(19) United States
(12) Patent Application Publication
(10) Pub. No.: US 2006/0218023 A1
(43) Pub. Date: Sep. 28, 2006

(54) Single premium term life insurance

(76) Inventor: Gerald L. Conrad, Irvine, CA (US)

Correspondence Address: STETINA BRUNDA GARRED & BRUCKER, 75 ENTERPRISE, SUITE 250, ALISO VIEJO, CA, 92656, US

(21) Appl. No.: 11/388,649

(22) Filed: Mar. 24, 2006

Related U.S. Application Data
(60) Provisional application No. 60/665,294, filed on Mar. 25, 2005.

(51) Int. Cl. G06Q 40/00; G06F 19/00

(52) U.S. Cl. 705/4; 705/3

(57) ABSTRACT

A method for generating a life insurance policy comprises the step of selecting an amount of a death benefit that is payable upon the death of an individual. The method may further comprise the steps of gathering prescription drug history and comparing the prescription drug history of the individual to that of a group having a substantially similar or similar prescription drug history. The method may additionally include the step of correlating a mortality rate from the equivalent prescription drug history of the group. The single premium may be based upon the death benefit amount and the mortality rate. The method may also include the steps of collecting the single premium from the individual and generating the term life insurance policy for the individual. Personal information about the applicant such as age, gender, tobacco use, etc., may also be included in the steps of generating the term life insurance policy.

### CROSS-REFERENCE TO RELATED APPLICATIONS

This application claims the benefit of U.S. Provisional Application No. 60/665,294, entitled SINGLE PREMIUM TERM LIFE INSURANCE filed on Mar. 25, 2005, the entire contents of which is expressly incorporated by reference herein.

### STATEMENT RE: FEDERALLY SPONSORED RESEARCH/DEVELOPMENT

(Not Applicable)

### BACKGROUND OF THE INVENTION

The present invention relates generally to insurance and, more particularly, to a uniquely structured single premium term life insurance policy for an individual wherein the policy is non-cancelable and a single premium is paid by the individual upon inception of the policy.

There are a variety of life insurance products available on the market. Life insurance allows the survivors of an individual to receive cash upon the death of the individual. The amount of cash received (i.e., the death benefit) by the survivors (i.e., beneficiaries) can provide financial assistance to help the survivor's family make mortgage payments, help with the general cost of living, paying off debt incurred by the individual, as well as paying expenses directly related to the death of the individual such as burial costs and estate taxes.

Life insurance may be provided in several different categories including whole life insurance and term life insurance. Whole life insurance provides protection during the lifetime of the individual for as long as premiums on the insurance policy are paid. Upon the death of the individual, the death benefit is paid to the beneficiaries of the whole life insurance policy. In addition, some whole life insurance policies allow for the individual to receive a cash value or lump sum for early cancellation of the policy prior to the death of the individual.

Term life insurance provides financial protection for a specified term or period of time. Notably, in a term life insurance policy, the death benefit is only payable if the individual dies during the term of the insurance policy. Some term life insurance policies are renewable at the end of the term if the insured agrees to pay additional premiums in order to extend the term. The term of the policy can be of any duration and can range from one year to twenty or thirty years. Typically, the premiums on term life insurance policies are payable on a monthly basis and typically increase with the age of the individual. However, certain term life insurance policies allow the individual to pay a constant or level amount on the premium during the term of the policy.

Recent data suggests that there exists a growing market for term life insurance. More specifically, such data indicates that from the period starting from year 1996 to the year 2000, the number of policies that have issued grew from just under 3 million to about 5 million. Correlated to such growth during the same period was an increase in the total face value amounts (in millions of dollars) of all life insurance policies from just over 1 million to about 1.3 million. It is also believed that certain market segments (i.e., certain demographics) have been underserved and that such markets could benefit from a term life insurance policy.

For example, recent data suggests that a vast majority of life insurance policies are sold to those having annul incomes of greater than $50,000. Conversely, those individuals with annul incomes of less than $50,000 are typically covered by insurance plans provided under an employee benefits program. However, a recent survey suggests that there is a high demand or desire among individuals earning less than $60,000 for term life insurance coverage wherein the life insurance policy has a benefit of $250,000 and under.

Unfortunately, despite this projected desire for term life insurance, it is believed that traditionally-structured term life insurance policies suffer from several deficiencies that detract from their overall profitability for insurance providers. For example, government regulations dictate reserving requirements that must be maintained for certain life insurance products. Such reserves are primarily intended to be the source from which claims are paid to the holder of a life insurance policy. The amount of the reserves that an insurance company must hold is dependent in part upon policy liability amounts.

A set of regulations known as “Regulation Triple X” governs such reserving requirements for life insurance. Such reserving requirements are based upon mortality tables such as those produced by the Society of Actuaries (SOA). Triple X regulations require life insurance issuers such as those selling term life insurance policies to provide higher reserve amounts than the amounts previously required. This increase in the reserving requirements has lead to an increase in premium rates for certain life insurance products due to increased re-insurance costs. Such re-insurance costs arise from the purchase of individual life insurance policies by large international financial institutions from the primary insurers.

However, the increase in premium rates for life insurance is also believed to result from a gap or disparity that exists between current mortality tables (i.e., SOA tables) and actual mortality rates. An investigation into the disparity reveals an increasing lifespan of the general population that is not properly represented by current SOA tables. Many re-insurance institutions are motivated to circumvent government regulations regarding reserving requirements by transferring 100% of the risk of the primary insurer to off-shore entities in exchange for receiving a portion of the premium that is charged to the individual.

The investigation further reveals that in the insurance coverage industry, little is known regarding actual causation of the mortality of individuals. This is due in part to current practice in the insurance industry to record only that information which is obtained during the insurance policy application process or from data that is obtained upon review of the issued policy. Such information may be entered into a relational database which may be correlated to the mortality rate. It is believed that most information available on the individual is only that which is obtained by scanning an image of the issued policy. It is believed that there is a lack of data regarding the mortality rate for individuals who are likely to maintain their term life insurance policy for its entire duration.

Notably, it has been learned that healthy individuals who purchase term life insurance policies are generally: (1) good credit risks, and (2) have a generally higher level of education and above-average income. More specifically, it is believed that individuals who are good credit risks and having an advanced degree and above average income have a generally low mortality rate. Regarding the credit-worthiness of individuals, credit information may be readily obtained using a system developed by the Fair Isaac and Co. and which is also known as the FICO scoring system. The FICO scoring system assigns a number to each individual which is representative of the likelihood that a credit user will pay their bills. Levels of education and income of individuals can be obtained from the insurance policy application.

Another deficiency of traditionally-structured term life insurance policies is related to certain administrative costs related to the insurance policy. Referring to FIG. 1, it has been discovered that for term life insurance policies, approximately 100% of the premium costs in the first year of the policy go toward a commission for the insurance sales agent who assisted and/or prepared the term life insurance policy application. Furthermore, it has been discovered that term life insurance providers do not realize a positive cash flow until approximately the fourth year of the term of the life insurance policy as is graphically illustrated in FIG. 1 which plots cumulative cash flow of a traditionally-structured term life insurance policy over a ten-year time period.

As can be seen, FIG. 1 illustrates the case for a 45-year-old, non-tobacco using male covered under a level-premium, fully underwritten life insurance policy. It has been learned that for such traditionally-structured term life insurance policies such as that plotted in FIG. 1, mortality costs as a percentage of premium collected is relatively high due to the fact that the life insurance policies that lapse (i.e., as a result of individuals failing to pay premium costs for the duration of the policy) are those that are owned by relatively healthy individuals. FIG. 1 further illustrated the persistency of such traditionally-structured term life insurance policies wherein only 40% of the insureds generally continue making premium payments throughout the duration of the term life insurance policy.

Such relatively high mortality costs as a percentage of premium are also due to the fact that individuals covered by life insurance policies that persist are often those who have developed certain conditions (e.g., medical conditions, life changes, etc.) that would render it difficult and costly to secure additional life insurance coverage through another insurance provider. A further deficiency of traditionally-structured term life insurance policy practices is that underwriting costs for the policy continue to be incurred even when premiums are not be paid. This may occur due to an applicant failing to follow through with the application process which may result from buyer's remorse, comparative shopping with other insurance providers or general confusion about the extent of coverage provided under the term life insurance policy. Applicant's also tend to drop out of the application process due to the intrusive nature of blood or urine tests required under many traditional term life insurance policies which further adds to the overall underwriting costs. Such additional underwriting costs are unfortunately added to the overhead in policy premiums for other individuals who decide to purchase a term life insurance policy.

A further deficiency associated with traditionally-structured term life insurance policies is that commissions that are typically paid to a life insurance agent are paid upon acceptance of the policy by the applicant and are taken out of the first monthly premium. However, it is often the case that only a single monthly premium is ever paid by the individual. Unfortunately, in such cases, commission losses must be included in the overhead pricing of the policy for others who ultimately purchase a term life insurance policy. Still a further deficiency associated with current term life insurance policies is that the underwriting procedure is typically expensive and time consuming.

For example, the underwriting process may require up to 6 weeks for completion. Other costs in providing the term life insurance policy which are passed on to purchasers of the life insurance policy are those associated with billing, endorsements and general administrative costs. In traditional term life insurance policies, such costs are built into the policy premium and are passed on to the consumer with a resulting increase in premium rates for the term life insurance industry. As was earlier mentioned, due to such increased costs that are passed on to the consumer, term life insurance providers do not realize a positive cash flow or a return on their investment until the fourth year of the premium that is paid.

As can be seen, there exists a need in the art for a term life insurance policy that is based upon mortality rates that more closely track the increasing lifespan of the general population than that which is suggested by current mortality tables (i.e., SOA tables). In addition, there exists a need in the art for a term life insurance policy wherein commissions that are paid to the insurance agent are assessed and paid independent of the premium in order to enhance profitability of the term life insurance policy. Furthermore, there exists a need in the art for a term life insurance policy wherein the underwriting costs are assessed and paid separate and apart from the premium payment. In addition, there exits a need in the art for a term life insurance policy wherein underwriting costs are relatively low due to the use of nontraditional data in establishing mortality rates.

Also, there exists a need in the art for a term life insurance policy that eliminates attrition throughout the duration or term of the life insurance policy such that virtually none of the term life insurance policies lapse due to nonpayment of premiums. Finally, there exists a need in the art for a term life insurance policy that generates positive cash flow starting from application of the policy throughout the duration of the policy. In this regard, there exists a need in the art for a term life insurance policy wherein the mortality cost of the life insurance policy is relatively low due to the fact that such mortality cost is paid from a larger pool of individuals who are covered by a term life insurance policy.

### BRIEF SUMMARY OF THE INVENTION

Provided is a term life insurance policy and method for generation thereof that is a single premium policy and which is based upon actual mortality rates. Importantly, the actual mortality rates of the term life insurance policy are determined using non-traditional underwriting factors or characteristics. More specifically, underwriting may be based upon prescription drug history of the individual, the individual's motor vehicle report, credit report (i.e., FICO score) as well as the individual's medical history. The actual mortality rates are also based in part upon additional information about the applicant such as age, gender and tobacco use which may be supplied by the applicant during the application process. Information such as prescription drug history is used to reverse diagnose medical conditions and plot impact on mortality rates.

As was mentioned above, the term life insurance policy utilizes a single premium that is paid up-front by the applicant. In this manner, the problems associated with attrition or lapsing of the term life insurance policy due to nonpayment of premiums is virtually eliminated. In addition, certain expenditures or costs that are incurred by the primary insurance provider are separated from the cost of the insurance such that income from the accumulated single premiums that are collected from applicants may be invested upon the first day of sale of the term life insurance policy.

Due to the up-front payment of the single premium, the policy may be configured as a non-cancelable term life insurance policy with no possibility of return of the premium to the individual. As was earlier indicated, all costs such as administrative costs are provided separate from the premium amount and are disclosed and assessed to the applicant. The term life insurance policy may be provided in a variety of durations and face value amounts. It should be noted that the term life insurance policy may provide a level death benefit feature and may also include an accidental disability or dismemberment benefit that may be equal to a certain percentage of the death benefit amount.

It is further contemplated that commission costs are assessed during the application process. In addition, basic administrative costs such as costs of copying, handling, and premium collection and mailing costs for the policy may be assessed during the application process. A fee may be charged for endorsement of the policy in order to cover change of address and/or change of beneficiary on the policy.

Importantly, the term life insurance policy of the present invention may be provided as a group policy wherein members of an entity such as a corporation or an institution may apply for such term life insurance policy on a non-cancelable basis. The group must have a common bond such as membership in a retail establishment, affinity to a credit organization such as a credit card company, or employment in a business. The underwriting process (wherein the individual is evaluated in order to determine the risks involved for the policy provider) is initiated with an analysis of the risk characteristics using the aforementioned prescription drug history and other characteristics that may be analyzed in order to arrive at a mortality rate.

The underwriting procedure provides a means for indicating any potential disqualifiers or indicators including, but not limited to, certain medical conditions, participation in certain activities such as hazardous sports or travel to certain parts of the world that are known to be unsafe or dangerous. Other indicators regarding smoking, consumption of alcohol, and drug use are also stated in the policy by the individual. A scoring algorithm may be used to analyze prescription drug history, motor vehicle report, credit history and medical history and may include a binary (i.e., yes or no) indicator of acceptance regarding the applicant's qualification for the term life insurance policy.

### BRIEF DESCRIPTION OF THE DRAWINGS

These as well as other features of the present invention will become more apparent upon reference to the drawings wherein:

FIG. 1 is a graph of persistency and cumulative cash flow plotted over a ten-year time period for a term life insurance policy of the prior art and illustrating the negative change in persistency level and the initially negative cumulative cash flow thereof;

FIG. 2 is a graph of persistency and cumulative cash flow plotted over a ten-year time period for a term life insurance policy of the present invention and illustrating a constant persistency level and an initially high cumulative cash flow;

FIG. 3 is a graph with the plots of cumulative cash flow for the term life insurance policy of the prior art of FIG. 1 superimposed with the term life insurance policy of the present invention; and

FIG. 4 is a graph which plots mortality rate vs. attrition rate over a ten-year time period for the term life insurance policy of the present invention.

### DETAILED DESCRIPTION OF THE INVENTION

Referring now to the drawings wherein the showings are for purposes of illustrating the present invention and not for purposes of limiting the same, provided is a system for a term life insurance policy for an individual that is based upon actual mortality rates. More specifically, provided is a term life insurance policy and method for generation thereof wherein the actual mortality rates of the term life insurance policy are based upon certain characteristics of the individual that correlate to an actual mortality rate. The invention may include an algorithm and procedure that gathers information such as prescription drug history, credit data, motor vehicle report data and medical history information in addition to information that is supplied by the applicant in order to generate the term life insurance policy. Information such as prescription drug history is used to reverse-diagnose and plot impact on mortality rates.

Importantly, the term life insurance policy utilizes a single premium that is paid up front by the applicant. In this manner, attrition or lapsing of the term life insurance policy and nonpayment of premiums is eliminated. In addition, certain expenditures that are incurred by the primary insurance provider are separated from the cost of the insurance. For example, underwriting costs, commissions, billing and endorsement costs and other administrative fees such as policy issuance fees are separated from the amount of the single premium. In this manner, investment income from the accumulated single premiums that are collected from applicants may be invested upon the first day of sale of the term life insurance policy.

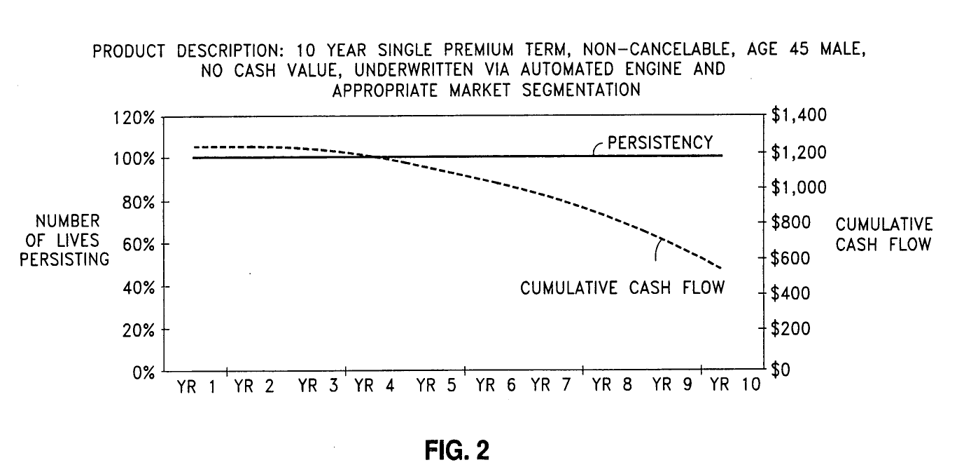

As shown in FIG. 2, the term life insurance policy of the present invention features a constant persistency level and an initially high cumulative cash flow which ultimately reduces overall costs for generating the term life insurance policy by about 30% compared to costs for generating a traditionally-structured term life insurance policy. FIG. 2 graphically represents the case for a 45-year-old, non-tobacco-using male covered under a term life insurance policy over a ten-year time period. Such policy has no cash value and is underwritten automatically such as by using an appropriate algorithm and/or procedure.

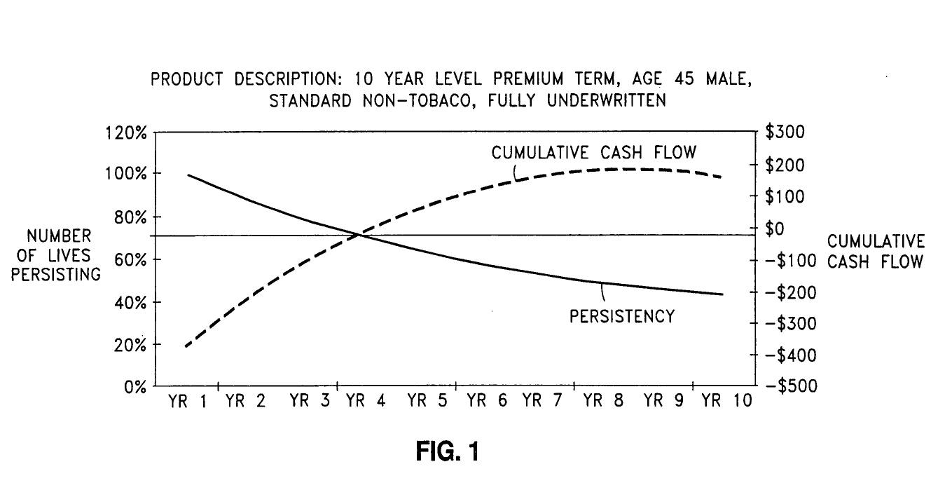

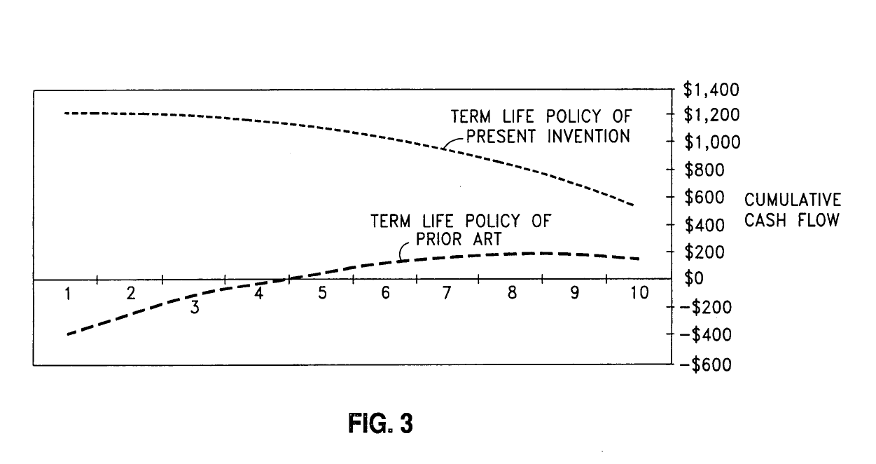

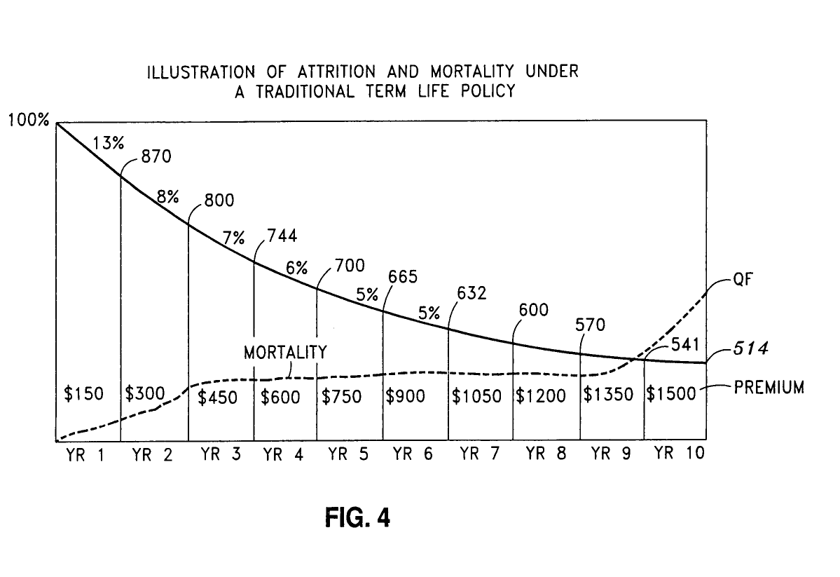

It should be noted that due to the single premium payment feature, the term life insurance policy generates a positive cash flow from inception of the policy and through the duration of the term resulting in a profit increase of about 300% compared to profits that are attainable using traditional term life insurance policy methodologies. Such increased profitability is graphically illustrated in FIG. 3 which superimposes plots of cumulative cash flow for the term life insurance policy of the prior art (as shown in FIG. 1) with the term life insurance policy of the present invention (as shown in FIG. 2). FIG. 4 is a graph of a traditional term life insurance policy which plots mortality rate vs. attrition rate over a ten-year time period. Represented by the solid curve, the attrition rate can be seen as relatively high (e.g., up to about 13 percent) in the initial stages of the ten-year period but starts to level out-toward the latter half of the ten-year-period. Conversely, the mortality rate represented by the dashed curve and indicated by the term “QF” remains relatively steady up to about the eight year after which the mortality rate increases relatively sharply.

In its broadest sense, the method for generating the life insurance policy may include the steps of selecting the amount of death benefit that is payable upon the death of the individual. The method may further comprise the steps of gathering prescription drug history, and comparing the prescription drug history of the individual to that of a group having a substantially equivalent or similar prescription drug history. The method may additionally include the step of correlating a mortality rate from the equivalent prescription drug history of the group. The method may further include the step of determining the amount of the single premium based upon the death benefit amount and the mortality rate. The method may also include the steps of collecting the single premium from the individual and generating the term life insurance policy for the individual. Personal information about the applicant such as age, gender, tobacco use, etc., may also be included in the steps of generating the term life insurance policy.

Due to the up-front payment of the single premium, the policy may be configured as a non-cancelable life term insurance policy with no return of the premium to the individual. As was earlier indicated, all costs such as administrative costs are separate from the premium amount and are disclosed and passed on to the applicant. The term life insurance policy may include policy term configurations in durations of 3, 5, 7 and 10 years and may have face value amounts on the order of about $50,000, $100,000, $150,000, $200,000, or $250,000. However, it should be noted that the term life insurance policy provided herein may be provided in any term duration and in any face value amount. Furthermore, the term life insurance policy may provide a level death benefit feature and may also include an accidental disability or dismemberment benefit that may be equal to a certain percentage such as 25%, of the death benefit amount.

The term life insurance policy may also include a credit life insurance option wherein the sole beneficiary of the term life insurance policy will be the lender of a loan for an instrument such as a mortgage, auto or personal loan. Upon the death of the individual, the insurance provider would pay the outstanding balance on the loan such as the mortgage with no proceeds going to any other individual or entity. It is contemplated that the amount payable on the credit life insurance option would be limited to and/or is proportional to the amount of premiums paid on the policy. In the event of a suicide or a fraud on the life insurance policy during the first two years of the duration of the term, it is contemplated that the death benefit is limited to and/or proportional to the amount of premiums paid.

As was earlier stated, the term life insurance policy is based upon a single premium paid upon inception of the policy. Furthermore, it is contemplated that the term life insurance policy provides no value other than the benefits or options indicated and accepted by the individual upon inception of the policy. Regarding amounts payable in the form of death benefits, it is contemplated that the term life insurance policy of the present invention may provide a minimum death benefit of about $50,000 and a maximum death benefit of about $250,000 although any amount may be provided as the death benefit amount.

It is also estimated that a standard fee may be incurred and passed on to the individual for underwriting in order to cover the costs associated with gathering information about the applicant such as the applicant's contact information. Furthermore, the underwriting costs may be incurred in order to cover the cost purchasing prescription drug history of the individual, the individual's motor vehicle report (MVR report), credit report (i.e., FICO report) as well as the individual's medical history such as information which is available from the Medical Information Bureau (MIB). In addition, the underwriting costs may be provided in order to cover the cost of verifying the individual's social security number.

It is further contemplated that commission costs payable to the insurance agent will be disclosed to the individual at the time of application and that such commission costs may be a one-time fee. It is contemplated that the amount of the commission cost may be approximately equal to or greater than the underwriting costs although the commission costs may be provided in any amount. A further cost for policy issuance may be assessed to the individual in order to cover basic administrative costs such as costs associated with copying, handling, and premium collection and mailing costs. An additional fee may be charged for endorsement of the policy with such fee being a nominal or relatively low amount in order to cover change of address and/or change of beneficiary on the policy.

Importantly, the term life insurance policy of the present invention may be provided as a group policy wherein members of an entity such as a corporation or institution may optionally apply for such term life insurance policy on a non-cancelable basis. The group must be commonly bound by a membership in a retail establishment, affinity to a credit organization such as a credit card company, or employees of an organization such as a corporation or a business. The underwriting process may initially include an evaluation of the individual as part of a group in order to determine the risks involved for the policy provider. The underwriting process may include an analysis of the group's risk characteristics such as the aforementioned prescription drug history and other characteristics. Such information may be plotted in order to arrive at a mortality rate.

It is contemplated that members of the group may be between the ages of about 20 and about 55. Furthermore, it is contemplated that such group members preferably are married, have a relatively stable credit history such as that which may be inferred by referring to the individual's FICO score. Furthermore, it is contemplated that at least one member of the group's family is employed. Finally, it is contemplated that the group member may be covered with a health benefit program. However, it is contemplated that various other group characteristics may be utilized in order to determine which members of the group are included during the underwriting process. For example, it is contemplated that members of the group may be of any age and may have any relationship status such as single, divorced or separated, etc.

Furthermore, individuals having various credit worthiness ratings and employment status as well as participation or nonparticipation in any health benefit program may participate in the term life insurance policy program. Regarding the underwriting methodology about which the risk of an individual applicant for the term life insurance policy is concerned, it is contemplated that premiums are at least partially based on the exact age of the applicant as determined by the applicant's nearest birthday. It is further contemplated that premiums for the term life insurance policy are based on current term life mortality rates as fully underwritten. If the applicant desires an increase in a cash value payable upon death of the individual, it is contemplated that additional charges may be assessed the applicant for such increases in the death benefit.

As was previously mentioned, determination of the life insurance premium is substantially dependent upon the duration of the term as well as the face value of the insurance policy. However, the life insurance policy of the present invention utilizes information based upon the prescription drug history of the applicant in order to reverse-diagnose and plot the impact on mortality rate. Furthermore, credit data and MVR data may be gathered. MVR data may be gathered from the state department of motor vehicles (DMV). Medical information may be gathered from the MIB (Medical Information Bureau) in addition to basic personal information of the applicant such as date of birth, gender, etc.

It is further contemplated that during the underwriting procedure, inquiries regarding the health status of the applicant will be clearly stated. In addition, it is contemplated that the underwriting process will indicate that the life insurance policy of the present invention is intended for individuals having the capability to finance a multiple year policy with its premium that is payable as a single lump sum in advance. However, it is also contemplated that financing may be made available in the form of an unsecured or secured loan in order to pay for the single premium for the life insurance policy.

The underwriting procedure will also provide a means for indicating any potential disqualifiers of the life insurance policy including, but not limited to, certain medical conditions. It is also contemplated that the applicant for the life insurance policy must directly affirm or deny whether such disqualifiers are applicable. Options will also be available for the individual to indicate their participation in certain activities such as hazardous sports or other hazardous activities such as skydiving. In this regard, travel to certain parts of the world that are known to be unsafe or dangerous may be used in disqualifying the individual from coverage under the life insurance policy.

Other disqualifiers or indicators regarding smoking, consumption of alcohol, and drug use must also be clearly stated in the policy by the individual. It is further contemplated that assessment of the individual's risk during the underwriting procedure may be preformed using a scoring algorithm taking into consideration the prescription drug history, motor vehicle report, credit history and Medical Information Bureau information. The scoring algorithm may optionally include a binary (i.e., yes or no) indicator of acceptance or decline regarding the applicant's qualification for the term life insurance policy of the present invention.

It is further contemplated that individuals who indicate or otherwise provide information regarding a smoking or tobacco use habit or history will not necessarily be disqualified from coverage under the life insurance policy. However, it is also contemplated that a surcharge may be assessed to the individual depending on certain characteristics that are also indicated as potentially increasing the risk or which may otherwise place the individual at a high mortality rate than average. In this regard, it is also contemplated that individual applicants with certain characteristics may be assessed a surcharge in proportion to their smoking habits as well as positively indicating that they have other negative characteristics.

Although insurance coverage may be provided at a certain cost for a certain quantity of face value, it is contemplated that the cost of the single premium payment may be based on any amount of coverage of the death benefit. For example, it is contemplated that the cost of the single premium payment may be based on each $1,000 worth of insurance coverage. Such cost for a quantity of insurance coverage is contemplated to be disclosed to the individual applicant at the mortality rate. Furthermore, the cost per unit coverage of insurance is preferably based on a fully underwritten term life insurance policy. Disclosures regarding the underwriting process will be clearly stated or indicated in the life insurance application so as to provide a history for the particular individual life insurance policy.

Regarding the assessment of costs, it is contemplated that the single premium is assessed separate from such costs. For example, it is contemplated that the cost of underwriting is to be a separate cost from the single premium payment. Notably, it is contemplated that such costs are relatively low compared to traditional means for underwriting term life insurance policies due to the use of prescription drug history and other nontraditional underwriting factors. For example, it is contemplated that the single premium payment may be provided at a rate of about $50 per application.

Because such underwriting cost is paid at the time of the application, it is contemplated that commission costs are also paid on a per-transaction basis. Such commission costs are also indicated on the application as being separate costs apart from the single premium payment. It is further contemplated that the cost of commissions will be a flat rate and will be independent of the cost of the single premium payment. Furthermore, the amount of such commission costs, like the underwriting costs, will be disclosed and passed on to the applicant of the insurance policy. Although the commission cost may be assessed in any value, it is contemplated that the commission cost may range in the area of from about $50 to about $100.

Administrative costs are also to be assessed apart from the premium payment cost. For example, photocopying, mailing and other similar functions will be assessed at a flat rate to the individual applicant. For example, endorsements of the life insurance policy may be charged to the consumer at a rate of about $10 per occurrence. Other costs such as a policy issuance cost may also be assessed to the individual applicant separate and apart from the single premium payment. For example, a cost of $25 may be assessed for the policy issuance fee and will be collected at the time of the application. Likewise, other costs will also be collected at the time of the application.

By assessing the costs apart from the single premium payment it is contemplated that the overall costs are about 30% less than those assessed using traditionally-structured term life insurance methodologies. In addition, due to the single premium payment, it is contemplated that the term life insurance policy will generate a positive cash flow upon application and through the duration of the term to issuance. More specifically, it is estimated that by using the methodology disclosed herein, it is contemplated that the term life insurance policy will result in a profit increase of about 300% compared to profits that are attainable using traditionally-structured life term life insurance policy methodologies.

Regarding financing of the life insurance policy of the present invention, it is contemplated that the methodology used in assessing risk for the issuance of credit cards may be applied for a secured or unsecured loan for the single premium payment. In addition, conventional installment loan criteria may be utilized in determining the credit worthiness of the individual in regard to financing of the life insurance policy of the present invention. It is believed that a relatively high interest rate may be assessed by the financial institution for a loan for the single premium payment of the life insurance policy of the present invention.

For example, it is contemplated that an annual percentage rate of about 10% to about 18% may be received due to subsidization of the interest rate. In regard to customers of certain financial institutions with whom individuals carry certain credit devices such as credit cards, it is contemplated that such financial institutions may extend certain ones of credit card holders the ability to charge the amount of the single premium payment to an existing credit card held by the individual of the institution. For example, it is known that certain financial institutions such as banks allow their existing customers to request transfers of balances from other financial institutions.

It is also known that such banks allow different interest rates to be charged for different transactions on certain credit cards held by their customers. Such customers may be applicants of the life insurance policy of the present invention and therefore may qualify for financing their term life insurance application and premium costs. By financing the single premium payment under such credit cards, insurance providers who are policy issuers thereby benefit due to the elimination of billing costs that would otherwise be passed on to their customers. Furthermore, reduced customer service, underwriting costs and retention of the policy holder is contemplated for the duration of the term of the policy. Advantageously, the individual applicant thereby is provided additional coverage for each dollar of single premium payment.

Other benefits provided by the life insurance policy of the present invention include a simplified application process, lower priced premium, and improved customer relations due to the improved face value amount available for the life insurance policy in relation to the cost of a single premium payment as compared to traditional life insurance policies. Finally, the term life insurance policy and methodology disclosed herein is believed to result in a higher profit margin for the policy provider as well as for the re-insurer due to lower costs of issuance of the policy as well as lower maintenance costs.

Additional modifications and improvements of the present invention may also be apparent to those of ordinary skill in the art. Thus, the particular combination of parts described and illustrated herein is intended to represent only certain embodiments of the present invention, and is not intended to serve as limitations of alternative device within the spirit and scope of the invention.

What is claimed is:

1. A method of generating a term life insurance policy for an individual based upon actual mortality rates of a group of individuals, the method comprising the steps of:
selecting a death benefit amount payable upon death of the individual;
gathering a prescription drug history of the individual;
determining a mortality rate from the prescription drug history;
determining a single premium cost based upon the death benefit amount and the mortality rate;
collecting a single premium from the individual; and
generating the term life insurance policy for the individual.

2. The method of claim 1 further comprising the steps of:
reverse-diagnosing a medical condition of the individual; and
determining the individual's mortality rate from the individual's medical condition.

3. The method of claim 1 further comprising the step of automatically underwriting the term life insurance policy.

4. The method of claim 3 wherein a cost of underwriting the term life insurance policy is separate from a cost of the single premium collected from the individual.

5. The method of claim 1 further comprising the step of paying a commission for preparing the term life insurance policy, the commission being based on a flat rate.

6. The method of claim 1 further comprising the steps of:
gathering a motor vehicle report of the individual;
gathering a motor vehicle report for a group of individuals having a substantially similar motor vehicle report;
comparing the motor vehicle report of the individual to that of the group; and
correlating a mortality rate of the individual to a mortality rate of the group.

7. The method of claim 1 further comprising the steps of:
gathering a credit report of the individual;
gathering a credit report for a group of individuals having a substantially similar credit report;
comparing the credit report of the individual to that of the group; and
correlating a mortality rate of the individual to a mortality rate of the group.

8. The method of claim 1 further comprising the steps of:
gathering a medical history of the individual;
gathering a medical history for a group of individuals having a substantially similar medical history;
comparing the medical history of the individual to that of a group; and
correlating a mortality rate of the individual to a mortality rate of the group.

9. The method of claim 1 further comprising the steps of:
gathering a history of smoking, alcohol consumption and drug use of the individual;
disqualifying the individual from coverage under the term life insurance policy based upon the history of smoking, alcohol consumption and drug use.

10. The method of claim 1 further comprising the steps of:
gathering a history of participation in hazardous activities of the individual;
disqualifying the individual from coverage under the term life insurance policy based upon the history of participation in hazardous activities.

11. The method of claim 1 further comprising the steps of:
gathering the individual's history of traveling to certain foreign countries;
disqualifying the individual from coverage under the term life insurance policy based upon the history of traveling to certain foreign countries.

12. A term life insurance policy as generated according to the method of claim 1 wherein the term life insurance policy is non-cancellable.

13. A term life insurance policy as generated according to the method of claim 1 wherein the term life insurance policy provides a death benefit.

14. A term life insurance policy as generated according to the method of claim 1 wherein the term life insurance policy provides a disability benefit.

15. A term life insurance policy as generated according to the method of claim 1 wherein the term life insurance policy provides a dismemberment benefit.

16. A term life insurance policy as generated according to the method of claim 1 wherein the term life insurance policy provides a credit option such that benefits under the term life insurance policy are payable to a lender of a loan to the individual.

17. A term life insurance policy as generated according to the method of claim 1 wherein the term life insurance policy is provided as a group policy.

18. The term life insurance policy of claim 17 wherein the group is comprised of members sharing a common attribute including at least one of the following common attributes: employment with a corporation, membership in a credit union, membership in a retail establishment.
